(19) United States
(12) Patent Application Publication
(10) Pub. No.: US 2024/0378133 A1
(43) Pub. Date: Nov. 14, 2024

(54) SYSTEM AND METHOD FOR DETERRING AND DETECTING ARTIFICIAL INTELLIGENCE USE IN ELECTRONIC FILE COMPOSITION

(71) Applicant: MAFFEI CONSULTING GROUP, LLC, Tucson, AZ (US)

(72) Inventors: Joshua MAFFEI, Tucson, AZ (US); Zachary SHARPELL, Oceanside, CA (US)

(73) Assignee: MAFFEI CONSULTING GROUP, LLC, Tucson, AZ (US)

(21) Appl. No.: 18/651,031

(22) Filed: Apr. 30, 2024

Related U.S. Application Data
(60) Provisional application No. 63/465,339, filed on May 10, 2023.

(51) Int. Cl. G06F 11/34

(52) U.S. Cl. CPC G06F 11/3485; G06F 11/3438

(57) ABSTRACT

A method for determining whether a work product's content was generated using undesirable means, such as artificial intelligence (AI), by tracking and analyzing user input data during content creation. The method calculates a variable representative of how a content of a work product is generated based on characteristics such as words typed, keystrokes, and total word count, thereby providing an assessment a likelihood that that the work product was generated by, for example, artificial intelligence.

### TECHNICAL FIELD

This application relates to systems and methods for detecting whether content of an electronic file may have been generated in a particular manner, for example using artificial intelligence (AI).

### BACKGROUND

In certain settings, such as academic settings, the use of information acquired from secondary sources, including Artificial Intelligence and/or Natural Language Processors (AI/NLP) has led to certain challenges. These challenges include the current difficulties to reasonably and reliably detect works or portions thereof composed, produced, or generated by such sources. In particular, it is difficult for educators, educational institutions, and other organizations to reasonably and reliably detect whether works or portions thereof submitted by persons, for example, students, were composed, produced, or generated by a source such as AI/NLP. Persons using AI/NLP or other available sources to compose, produce, and/or generate works or portions thereof while representing that the submitted work has been generated firsthand can, among other things, undermine academic integrity and institutional integrity while hampering the learning process.

Other deterrence and/or detection methods and means rely upon fine-tuned language models that have been trained on datasets that pair human-written text and AI-written text on the same topic, essentially attempting to detect AI/NLP use by examining the text itself instead of monitoring the process by which the work was composed, produced, or generated. One problem with the existing deterrence and/or detection methods is that examining the text itself requires extensive processing load on the hardware processor performing the deterrence and/or detection. These methods and means also produce a low rate of overall detection, are unreliable on other languages besides English, and are particularly unreliable on short texts, code, predictable text, and in the long-term as AI/NLP output becomes more sophisticated and humanlike. Such systems generally tend to be unreliable outside of training data and also are often very bulky, data intensive systems that can run slowly and/or take a significant amount of memory or processing power.

Further, such systems often fail to detect plagiarized text when the text comes from AI/NLP because AI/NLP is both intended to produce text that is similar to human-written text and was developed/trained by human-written text. Thus, text-driven detection mechanisms often cannot accurately detect the text generated currently by AI/NLP, and may not do so in the future as AI/NLP systems improve.

### SUMMARY

In some aspects, the disclosed system and methods address these issues by providing an efficient and reliable solution for detecting whether the content of an electronic file may have been generated in a particular manner, for example using AI.

According to one aspect, the disclosure provides a method for calculating a variable representative of how a content of a work product is generated. The method includes recording, by a first processor, in a first memory, (i) a first value indicating a first characteristic of the content of the work product and (ii) a second value indicating a second characteristic of the content of the work product, transmitting, from the first memory to a second memory, the first and second values, retrieving, by a second processor distinct from the first processor, from the second memory, the first and second values, and calculating, by the second processor, a variable representative of how the content of the work product was generated based on the first and second values.

According to another aspect, this disclosure provides a non-transitory computer readable medium for calculating a variable representative of how a content of a work product is generated, the non-transitory computer readable medium storing a program that is executable by a computer to perform processing. The processing including retrieving, from a memory, first and second values, the first value indicating a first characteristic of the content of the work product and the second value indicating a second characteristic of the content of the work product, and calculating, the variable representative of how the content of the work product was generated based on the first and second values.

According to another aspect, this disclosure provides a system for calculating a variable representative of how a content of a work product is generated. The system including a first processor including a first memory, the first processor being configured to: record a first value indicating a first characteristic of a content of a work product over time, record a second value indicating a second characteristic of the content of the work product, and transmit, to a server, the first and second values. The system further includes the server, configured to transmit the first and second values to a second processor including a second memory. The system further includes the second processor including the second memory, the second processor distinct from the first processor, the second processor being configured to, receive, in the second memory, the first and second values, retrieve, from the second memory, the first and second values, and calculate the variable representative of how the content of the work product was generated based on the first and second values.

The claimed features provide advantages for calculating a variable representative of how a content of a work product was generated by, for example, using recorded values indicating first and second characteristics of a content of the work product, which may be collected independent of developments in new AI/NLP models or autonomous updates because the first and second characteristics necessarily exist in the work product. The first and second characteristics of the content of the work product may be collected for content of work product of varying languages, thereby removing language barriers from hampering the ability to calculate the variable representative of how a content of a work product was generated. Calculating the variable representative of how a content of a work product was generated does not rely on existing data regarding other content that was generated which may be compared to the content of the work product because the first and second values are related to only the work product itself. Calculating the variable representative of how a content of a work product was generated is based on the first and second values, which significantly reduces the amount of processing power required of the second processor when compared to the methods that require running the content of the entire work through an algorithm. In addition, the reduction of the load may be realized by the second processor alone, or by the system as a whole. In other words, when factoring in the processing requirements of the first processor collecting the first and second values, the overall system's processing load requirements are reduced when compared to methods that require running the content of the entire work through an algorithm.

### BRIEF DESCRIPTION OF THE EMBODIMENTS

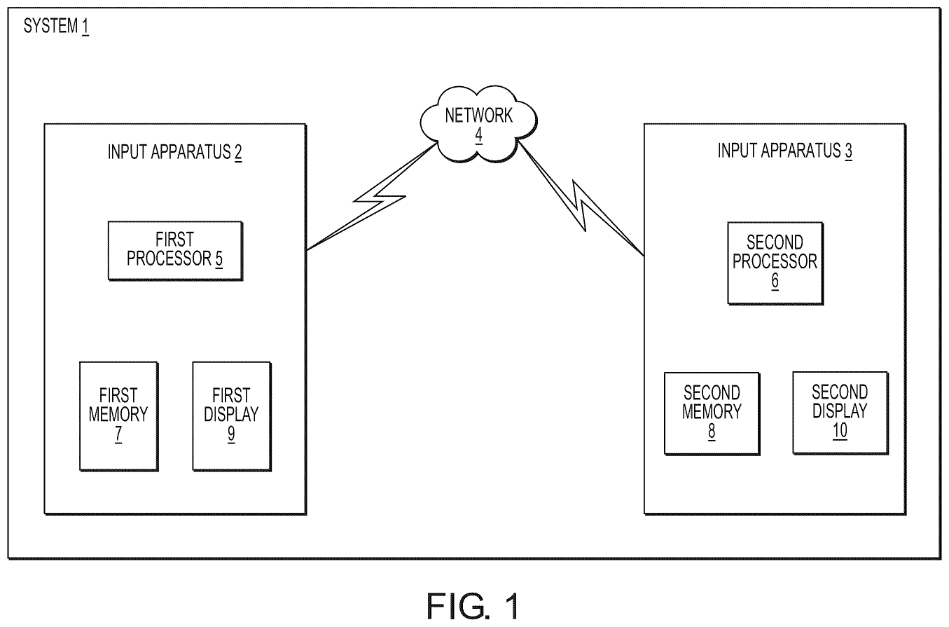

FIG. 1 is a diagram of a system according to some embodiments.

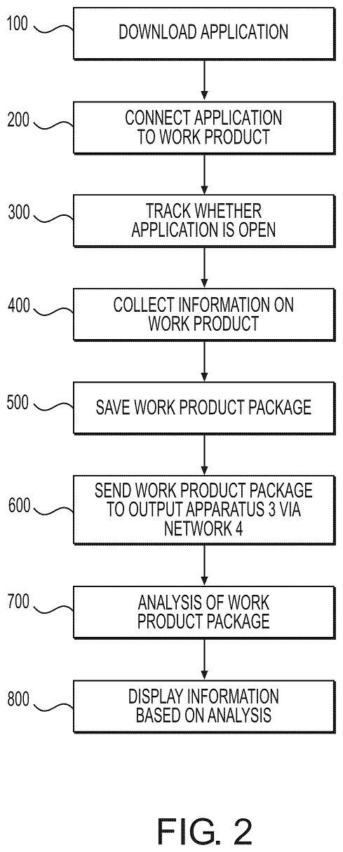

FIG. 2 is a flowchart of a method according to some embodiments.

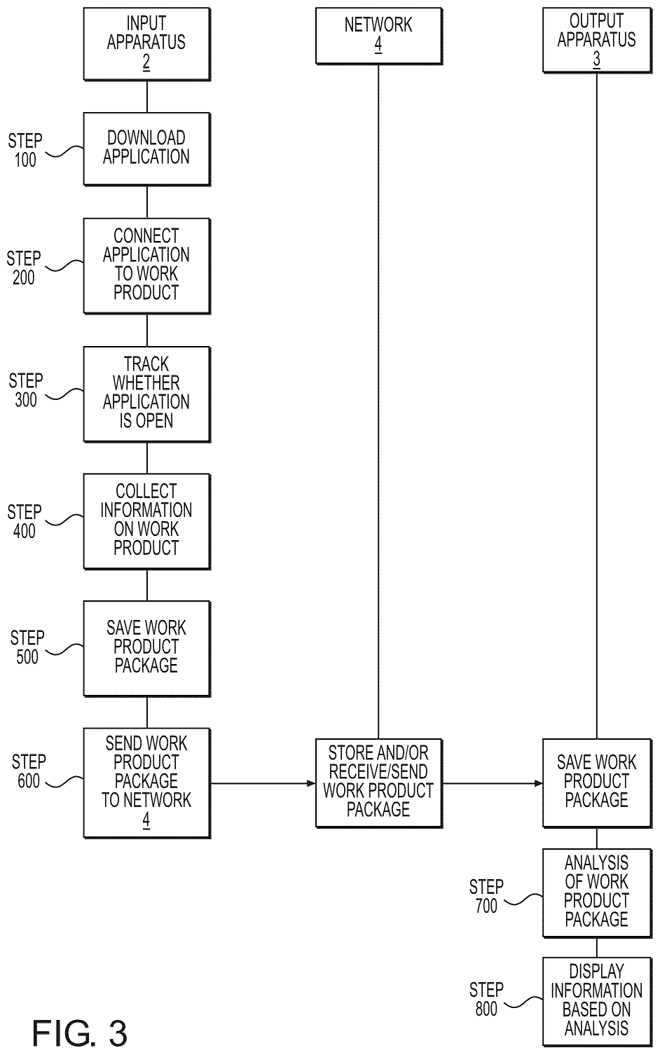

FIG. 3 is a vertical flowchart of a method according to some embodiments.

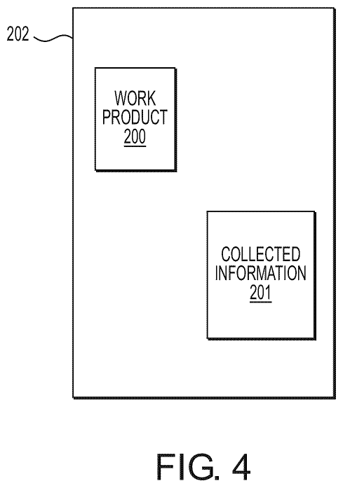

FIG. 4 is a diagram of the work product package.

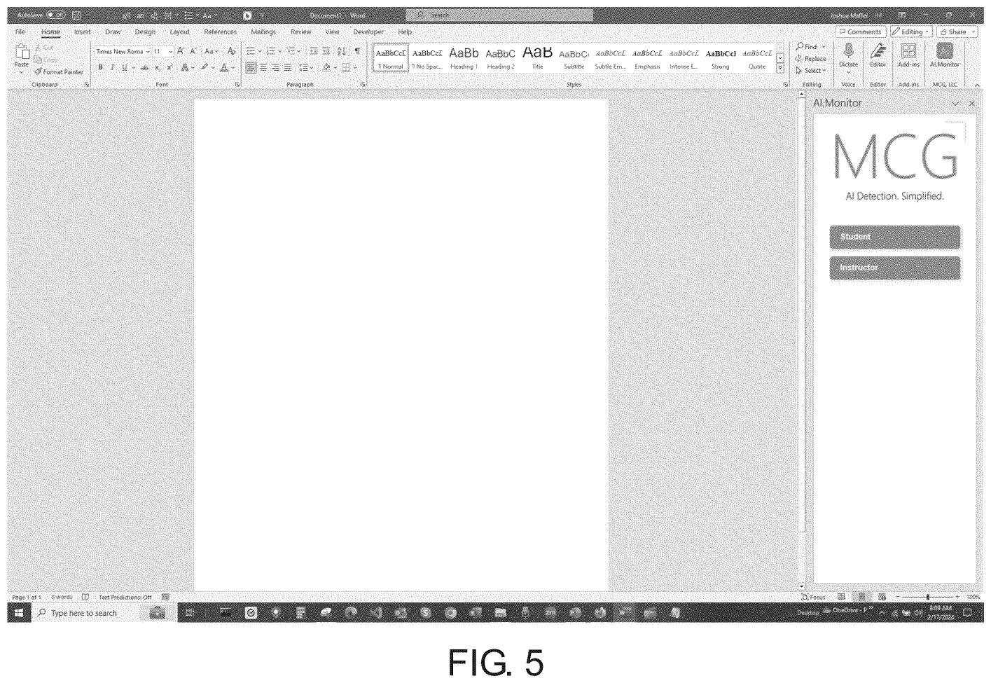

FIG. 5 shows an implementation of the application according to some embodiments.

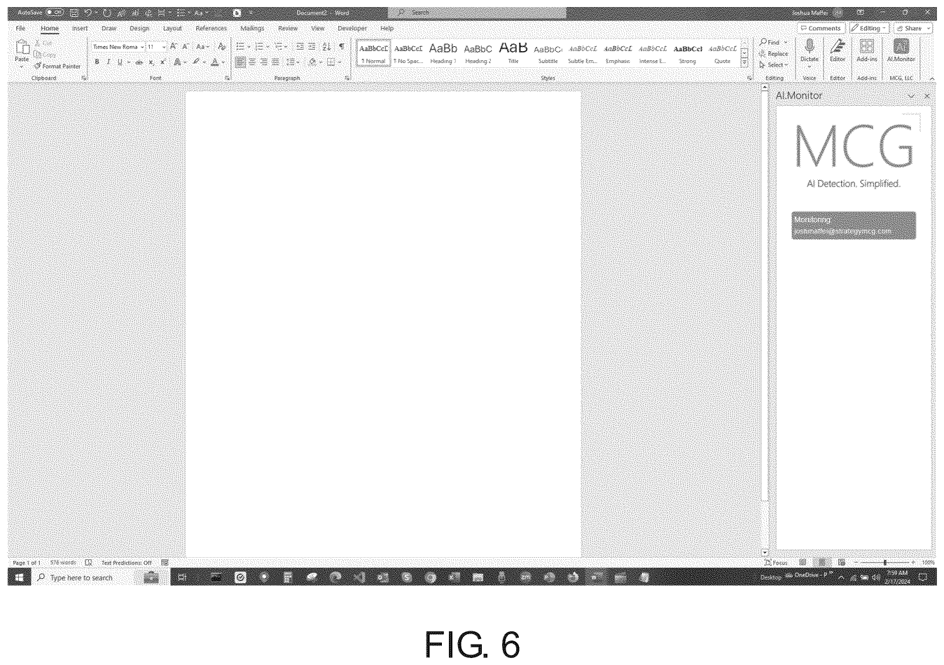

FIG. 6 shows an implementation of the application according to some embodiments.

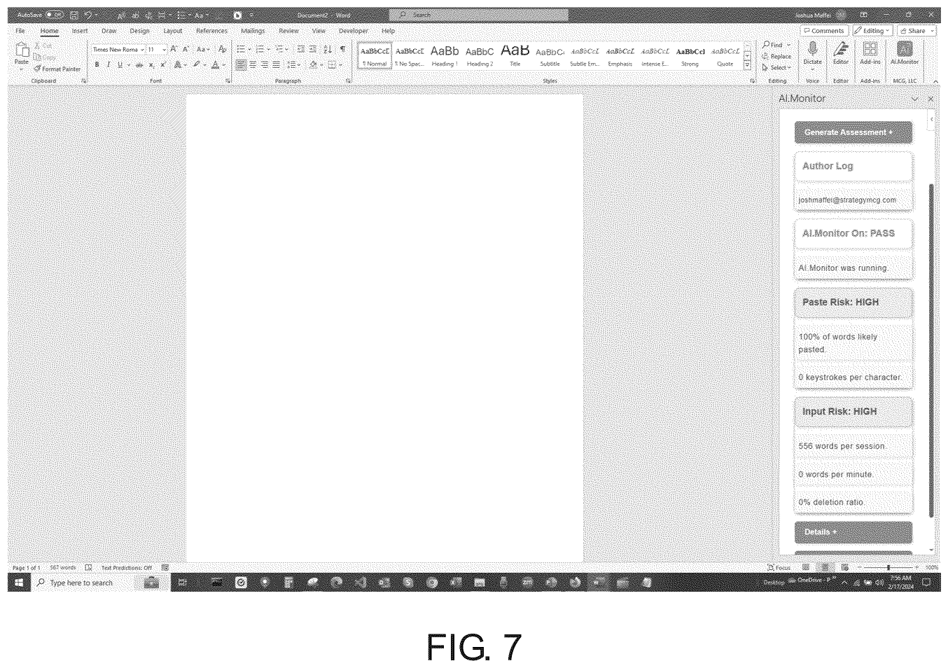

FIG. 7 shows an implementation of the application according to some embodiments.

### DETAILED DESCRIPTION OF EMBODIMENTS

In the following description, numerous details are set forth to provide an understanding of the present disclosure. However, it is understood by those skilled in the art that the apparatus and method of the present disclosure may be practiced without these details and that numerous variations or modifications from the described embodiments may be possible.

Embodiments of the present disclosure provide a method, computer readable medium, and system for determining a variable representative of how the content of a work product 200 was generated based on information collected during the generation of the work product 200. The variable representative of how the content of the work product 200 was generated may be used to estimate whether the content of the work product 200 was generated in a particular manner, for example with AI/NLP. These and other features are described in detail below in connection with FIGS. 1-7.

As used herein, the term “work” encompasses electronic papers, electronic files, and any form of text-based electronic files. As used herein, the term “student” refers to any user that creates the work product 200. As used herein, the term “educator” refers to any user that checks whether the work product 200 may have been generated in a particular manner, for example using AI.

### (1-1) Traditional Methods of Detecting AI/NLP

The instant application addresses at least some deficiencies in detecting AI/NLP use, as provided below. Traditional methods of estimating whether the content of work products was generated using AI/NLP creates questions about the reliability and consistency of their results and fails to provide proper evidence of AI/NLP use. One fundamental issue with traditional methods is that they operate using black-box algorithms that have been trained to recognize presumed word choice patterns of AI/NLPs. The traditional method creates severe practical issues as follows:
(i) Infinite Prompt Variability—Students using AI/NLPs do not have to use simple prompts such as, “Write me an essay on Romeo and Juliet.” They can use more sophisticated prompts such as, “Write me an essay on Romeo and Juliet which is elevated by employing literary language.” Prompt variations made by students can and will degrade the reliability of other AI/NLP “detectors.”
(ii) Continual Updates—AI/NLPs are dynamic and ever-evolving. Models, like ChatGPT, are continually updating, making their own performance better and better over time. As a first principle, every AI/NLP model is designed to learn. As the AI/NLP models learn and update, the reliability and consistency of AI detection, which depends on the identification of word patterns, becomes degraded. This degradation of reliability and consistency is due to the previous dataset used by the AI/NLP “detection” algorithms becoming outdated.
(iii) New Models—New Models are guaranteed. Each model has its own unique word choice pattern. As a result, AI/NLP “detectors” need to be trained on entirely new sets of data each time a new AI/NLP model is released, leaving them unreliable until updated.
(iv) Personalized AI—AI/NLP models may be individual trained by the student. This means that students have the ability to provide a set of their own writings to train the AI/NLP model mimic their writing. Traditional AI “detectors” have no ability to account for this level of personalization.
(v) Public Availability—Existing AI “detectors” make their tools publicly available; this allows student the opportunity to test whether or not their AI/NLP generated essay will be flagged for AI/NLP plagiarism prior to submitting their work.
(vi) Human+AI—Students modify AI written essays and each edit a student makes degrades the reliability and consistency of traditional AI/NLP “detectors”.
(vii) Paraphrase Bot Attack-Software may be used to rewrite the AI/NLP generated essays to avoid detection by AI/NP “detectors.”
(viii) Language Bias—Biases exist against non-native English students. Content written by non-native English students are more likely to be identified as being generated by AI/NLP models.
(iv) Student Privacy—Traditional AI/NLP “detectors” require students to relinquish control on the privacy of the work they produce as examples. Traditional AI/NLP “detectors” require referring the examples for referential comparisons.
(x) Processing Load—Traditional AI/NLP “detectors” require large amounts of computer processing power because they require running the content of the entire text through an algorithm.

The presented disclosure addresses these problems and more. Detailed benefits of the disclosed solutions are provided below with reference to Example 1.

### (1-2) Explanation of Hardware and Software

Referring to FIG. 1, in an embodiment, the method may be performed by a system 1 including an input apparatus 2, a network 4, and an output apparatus 3. The input apparatus 2 and the output apparatus 3 may be, for example, a physical server or circuitry of a physical server, or a computer. Alternatively, the input apparatus 2 and the output apparatus 3 may be a cloud server, or virtual circuitry of an abstraction layer of a cloud server, running in a cloud computing environment on the Internet. The input apparatus 2 may have a first hardware processor 5, a first memory 7, and a first display 9. The output apparatus may have a second hardware processor 6, a second memory 8, and a second display 10. The memories store information (for example, programs and various data), and the processors function based on the information stored in the memories. The functions of the processors may be realized by individual hardware, or may be realized by integrated hardware. Also, the processors, the memories and the displays may be respectively integrated in the input apparatus 2 and output apparatus 3, as shown in FIG. 1. Alternatively, the processors, the memories and the displays may be partially or completely remotely arranged with respect to each other. For example, the displays may be remotely located and connected to the processors via the network 4. The network may include a wireless communication network, the Internet, a VPN (Virtual Private Network), a WAN (Wide Area Network), a wired network, or any combination of these, or the like.

The processors may each be, for example, a central processing unit (CPU). However, the processor is not limited to a CPU, and various processors such as a graphics processing unit (GPU) or a digital signal processor (DSP) can be used. The processor may be a hardware circuit based on an ASIC. The term “processor” encompasses both a single processor and multiple processors.

The memories may each be a semiconductor memory such as a static random access memory (SRAM) or a dynamic random access memory (DRAM), a register, a magnetic storage device such as a hard disk device, or an optical storage device such as an optical disk device. For example, the memories may each store computer readable instructions, and the respective processor executes the instructions to realize the function of each part of the apparatus and method. The instructions here may be instructions constituting the program or instructions for the hardware circuit of the processor to perform the method.

The displays each include a display device such as a liquid crystal display or an organic EL (electro-luminescent) display. The displays each can display various images. The displays each are constituted by, for example, a computer screen, and functions to display data output by the processors. The processors may cause the displays to output information including display images. Alternatively, the processors may transmit data to another processor, which in turn causes the displays to output the information, including the display images.

### (1-3) Explanation of System and Method

Embodiments of this application may focus detection efforts on the process by which the electronic work and portions thereof were composed, produced, or generated. The system according to some embodiments may include the input apparatus 2 having the first hardware processor 5, e.g., a computer, that may be operated by a student or other user (hereinafter referred to as a student). The system may further include the output apparatus 3 having the second hardware processor 6, e.g., a computer, that may be operated by an educator or educational institution, or some other organization (hereinafter referred to as an educator). The input apparatus 2 may be configured to send submission information to the output apparatus 3 via the network 4. The input apparatus 2 may include input components including a keyboard, microphone, speaker, and/or a mouse and the processor may receive user-entered information from the input components. The output apparatus 3 may include the second display 10, which includes a display screen to show outputs.

In some embodiments, the educator may create and enforce a policy that requires the student to utilize an application on his/her computer. The application may be integrated with existing computer software, for example within a word processing program (e.g., a macro or a plug-in thereto), or may be an entirely separate application that is required to be active for the duration of the student preparing a document (i.e., work product 200). For convenience, either embodiment will be referred to herein as the “application.” In an embodiment, the application may be understood to be used for determining a variable representative of how the content of the work product 200 is generated and whether the work product 200 was generated in a particular manner, such as using AI/NLP. As used herein, the variable representative of how the content of the work product 200 is generated may be any result of metrics relating to preparation of the work product 200 that can be used for determining whether the content of the work product was generated using an undesirable source, such as AI/NLP.

The steps of the method are described with reference to FIGS. 2 and 3. In an embodiment, the method includes Step 100, in which the student downloads the application to the first memory 7 of the input apparatus 2. Downloading the application may include accessing the application via a module or extension integrated with an existing program. For example, the application may be downloaded via a Microsoft “add-in.” Other ways of downloading the application may include downloading an executable file that installs the application as a standalone program, or as an add-in to another word processing system. Access to the application may be verified by sending a signal, via the first hardware processor 5, to a server to validate a subscription to the application.

Referring again to FIGS. 2 and 3, in Step 200, the student will connect the application stored in the first memory 7 to the work (work product 200) on which the student is preparing. Here, connection between the application and the work product 200 means that the application begins obtaining real-time information regarding the work product 200 and stores the information in the first memory. FIG. 5 provides an exemplary layout of an initial screen displayed after the application has been downloaded. In particular, FIG. 5 shows a task pane including the name of the application (“AI Monitor”), a student button 101 and an instructor button 102. Referring again to FIG. 5, the student initiates a connection between the application and the work product 200 by selecting student button 101. Referring to FIG. 6, after selecting the student button 101, the student is provided with a student view of the application.

Referring again to FIGS. 2 and 3, in Step 300, system may track whether the student keeps the task pane open while work is being done to the work product 200. If the task pane is closed, i.e., if the application monitoring is disabled, the connection between the application and the work product 200 is ended and session count information is stored in first memory 7. The writing session count information represents the number of times the work product 200 has been opened and closed.

Referring again to FIGS. 2 and 3, in Step 400, the application will, in real-time or near-real-time, capture, track, evaluate and display the work product 200 data and logically derived metrics, for example as shown in FIG. 7. For example, the application may collect information on the work product 200, as collected information 201, including editing time, character count, word count, keystrokes (i.e., the number of times the student physically presses a key of a keyboard used to generated the content of the work product 200), file open and close count, creation timestamp, access timestamps, modification time stamps, electronic file author, last modifier of electronic file, and key depression combinations (ctrl+v as an example) as well as logically derived metrics. The collected information 201 may be a single value or may be a plurality of values indicating a characteristic of the work product 200. The single value may be a value representing a characteristic of the work product 200 after it has been finished, such as the number of times the file has been opened and closed. The plurality of values may represent a characteristic of the work product 200 that changes over a predetermined amount of time, such as the character count, the word count, and the keystrokes. The embodiment is not limited to these examples and may include any characteristic of the work product 200 that may be used to estimate how the content of the work product 200 was generated. The collected information 201 is an example of metrics that may be used for calculating the variable representative of how the content of the work product was generated.

The collected information 201 may be collected periodically while the work product 200 is connected to the application. For example, the application may retrieve values of characteristics of the work product 200, such as the character count, about every 2 seconds or 4 seconds. The disclosure is not limited to this amount of time or these characteristics and any amount of time and characteristic may be used such that the collected information is suitable for determining whether the content of the work product 200 was generated in a particular manner, such as using AI/NLP.

Logically derived metrics may include the writing session count, keystroke count (if unable to be captured directly from electronic file), editing time (if unable to be captured directly from electronic file), word count (if unable to be captured directly from electronic file), reasonableness of keystrokes compared to total editing time, reasonableness of keystrokes compared to periodic editing time, reasonableness of total word count compared to total editing time, reasonableness of word count increases compared to periodic editing time, reasonableness of total character count to total editing time, reasonableness of character count to periodic editing time, reasonableness of writing sessions to word count, reasonableness of writing session count compared to word count, reasonableness of keystrokes compared to word count, reasonableness of keystrokes compared to character count, and reasonableness of word count increases directly following key depression combinations. If there are no values saved for a metric, then the application will assign a first value for all logically derived metrics and a second value for electronic file data except for writing sessions which will be assigned a third value. The first value may be representative of there being no value saved for a metric. The second value may be a value of the electronic file data representative of there being no value saved for the metric. The third value may be a value representative that the number of writing sessions is one.

Referring again to FIGS. 2 and 3, in Step 500, student uses the interface of the application to save the work product 200 in the first memory 7 as a work product package 202. Referring to FIG. 4, the work product package 202 may include content of the work product 200 and the collected information 201 of the work product 200. The work product package 202 is maintained on the input apparatus 2 until the work product package 202 is re-opened and thereafter may be reconnected to the application, for example as discussed in Step 200, for continued monitoring. Once the student finishes performing work on the electronic work, either for the time being or in finality, the student will save the file or perform some other action that will trigger the application to store the values of the aforementioned logically derived metrics as well the values of the aforementioned electronic file data into a local hardware storage (e.g., the first memory 7), a networked server storage, and/or a cloud storage or the like.

Referring again to FIGS. 2 and 3, in Step 600, the student then sends the work product package 202 output apparatus 3 for instructor evaluation. In an embodiment, the student may send the work product package 202 via email. In other words, the first hardware processor 5 is instructed to retrieve the work product package 202 from the first memory 7 and the first hardware processor 5 sends the work product package 202 via the network 4. The work product package 202 may then be stored in the network 4 in a dedicated database. The work product package 202 may alternatively be sent directly to the output apparatus 3 via the network 4 by, for example, email. Upon receipt of the email, output apparatus 3 may then use the second hardware processor 6 to save the work product package 202 to the second memory 8.

Referring again to FIGS. 2 and 3, in Step 700, the instructor evaluates the work product 200 by first accessing the work product package 202 in the second memory 8. The instructor instructs the output apparatus 3 to retrieve the work product package 202 from the second memory 8 using the second hardware processor 6. The work product package 202 is then opened using existing software on the output apparatus 3, and the instructor then opens the application. Referring again to FIG. 5, the instructor may then select the instructor button 102. Upon selecting the instructor button 102, or upon opening of the application, the application then performs an evaluation of the collected information 201 and, referring to FIG. 7, the instruction is provided with an instructor view. This evaluation is discussed in further detail below.

Referring again to FIGS. 2 and 3, in Step 800, a display of the output apparatus 3 displays information based on the evaluation of the collected information 201. The instructor may then use the displayed information to make a judgment of the work product 200 and whether AI/NLP or another undesirable source was used to generate the content of the work product 200. Other undesirable sources are not limited to AI/NLP and may include any other source that is not firsthand input by the user. The display information may include information regarding how high different types of risk are associated with the results of the evaluation. Based on the displayed information, the instructor may then judge whether AI/NLP was used to generate the content of the work product 200. The instructor may receive guidance from the application, for example, when certain metrics are detected by the application, the educator may receive an alert that AI/NLP use is likely according to certain predetermined criteria, described later. Referring to FIG. 7, the application may also show specific variables and logically derived metrics along with a log of particular information.

### (1-3) Explanation of Evaluation of the Work Product

In Step 700, analysis is performed on the work product package 202 in order to determine a variable representative of how the content of the work product was generated. The instant embodiment provides an example of how the variable is determined and variations on the instant embodiment are provided. The disclosure is not limited to only the instant embodiment and variations and may include additional variations or a combination of any of the disclosed variable-determining solutions.

### Example 1-Paste Risk for Words

By way of non-limiting example, criteria of the work product 200 may be used to estimate whether certain real-world actions were taken while generating the content of the work product 200. One common real-world action includes using AI/NLP to generate a body of text or otherwise pull from an undesirable source, copying that text, and pasting that text into the word product 200. As a result, this creates a disparity between the number of words typed in the work product 200 and the number of words in the work product 200, because the words being pasted into the work product will register as no words being typed. In other words, the number of words typed will be less than the word count of the work product 200. The greater this disparity, the more likely that the content of the work product 200 was pasted, thereby indicating that AI/NLP or some undesirable source was used to generate the content.

In view of this, in an embodiment, determining the variable representative of how the content of the work product 200 was generated is as follows. A first value indicating a first characteristic of the content of the work product 200 is the number of words typed in the work product 200 and a second value indicating a second characteristic of the content of the work product 200 may be the word count of the work product 200.

Referring again to Step 700, the analysis performed on the work product package 202 includes calculating a variable that is representative of how the content of the work product 200 was generated. In this example, this variable is generated based on the first and second values. As discussed above, as an example, the first and second values may respectively be the number words typed and the word count of the work product 200. In this example, the variable may be a ratio between the first and second values and may be a ratio of the number of words typed to the word count. Referring to FIG. 7, the ratio may be expressed as a percentage from 0% to 100%. Based on the percentage, the application may cause the output apparatus 3 to display, on the second display 10, the percentage of the content that was pasted into the work product 200. In addition, the application may cause the output apparatus 3 to display, on the second display 10, a likelihood that the work product was generated by un undesirable source, such as AI/NLP, based on the percentage. The likelihood may include “HIGH,” “MEDIUM,” or “LOW.” For example, if the percentage of words pasted is greater than 50%, the likelihood may be high, if the percentage of words pasted is between 35% and 50%, the likelihood may be medium, and if the percentage of words pasted is below 35%, the likelihood may be low. These thresholds are provided by way of example and are not limiting and any threshold may be used which captures a risk that the content is being generated by an undesirable source.

Example 1 is instructive for a discussion of some technical improvements achieved by this disclosure.
(i) Future-Proof Design-In the embodiment, the features are performed independent of new AI/NLP model or autonomous updates, such that it does not require being updated in response to new AI/NLP models being developed, at least partially because the detection relies upon a consistent metrics independent of the source material, such as words typed and a total word count, the determination can be performed independent of new AI/NLP models or autonomous updates.
(ii) Transparent & Understandable Method-In the embodiment, rather than using black-box algorithms, simplified metrics are examined and analyzed such that the instructor can easily understand the risk of whether the content was generated using AI/NLP. For example, referring to FIG. 7, the instructor may be presented with, on the second display 10, information providing a clear understanding of what metrics are being used for making a determination of how the content of the work product 200 is generated.
(iii) Omni-Lingual Capability—In the embodiment, linguistically diverse individuals are not marginalized through existing biases in traditional AI/NLP detection. The embodiment provides the same level of functionality for writers of any language ensuring the same experience regardless of language used. The metrics, such as words typed and a total word count, do not rely on any particular language and can be performed independent of new AI/NLP models or autonomous updates.
(iv) Improved Privacy—The embodiment does not require collecting or storing of the user's writings, thereby improving the privacy of the student. The embodiment relies on collecting metrics, such as words typed and a total work count, which do not reveal the substance of the content of the work product.
(v) Protected Detection Methodology—As discussed above, the embodiment includes two views, a student view and an instructor view. The student view collects metrics on a student's writing process in real-time while concealing those metrics from them. The instructor view provides educators an easy to use assessment of a student's writing pattern as well as detailed documentation of the metrics used for the analysis. This two view design hinders the ability for students to bypass detection by providing educators full insight into their student's writing process. Referring to FIG. 6, the embodiment may display, on the first display 9, in Step 300, the student view which includes information that the application is merely running without the showing the metrics being collected. Referring to FIG. 7, in contrast, the embodiment may display, on the second display 10, in Step 800, the instruction view which includes the results of the metrics having been collected.
(vi) Reduced Processing Load—The embodiment requires low resource monitoring of the work product 200 while being generated and the evaluation of the work product 200 requires basic arithmetic calculations. As a result, the embodiment greatly reduces the processing load of the system 1 and particularly reduces the processing load of the second hardware processor 6 of the output device. Of course, in alternative embodiments, the reduction in processing load may be realized in any computer tasked with performing the evaluation of the work product 200, such as a cloud computing computer.

### Example 2-Paste Risk for Characters

As a second example, either in addition to or instead of the first example, a second solution for determining the variable representative of how the content of the work product 200 was generated is as follows. Example 2 relies on the inventor's discovery that copying and pasting text into the work product 200 creates a disparity between the number of keystrokes and the final character count of the work product 200. In view of this discovery, the first value indicating the first characteristic of the content of the work product 200 is the number of keystrokes typed in the work product 200 and the second value indicating the second characteristic of the content of the work product 200 is the final character count of the work product 200.

In the second example, referring again to Step 700, the analysis performed on the work product package 202 includes calculating the variable that is representative of how the content of the work product 200 was generated. In this example, the variable may be a number of keystrokes per character. The application may cause the output apparatus 3 to display, on the second display 10, the number of keystrokes per character in the work product 200. In addition, the application may cause the output apparatus 3 to display, on the second display 10, the likelihood that the work product 200 was generated by AI/NLP based on the number of keystrokes per character. For example, if the number of keystrokes is less than the number of characters, the system may assess there to be a “HIGH” likelihood of paste risk.

The first and second examples are not mutually exclusive and the likelihood that the work product 200 as generated by AI/NLP may be based on a combination of the percentage of the content that was pasted into the work product 200 in Example 1 and the number of keystrokes per character in Example 2. In an embodiment, the likelihood that the work product 200 was generated by AI/NLP may be “MEDIUM” if the percentage of the content that was pasted into the work product 200 is <35% and the number of keystrokes per character is in a range of 1 to 1.15. The above-discussed example is not limiting and a person of ordinary skill in the art would understand that the likelihood that the work product 200 was generated by AI/NLP may include additional combinations of using the percentage of the content that was pasted into the work product 200 and the number of keystrokes per character such that this information is used for estimating whether the content of the work product 200 was generated by AI/NLP.

Example 2 provides similar advantages as (i)-(vi), discussed in Example 1. For instance, Example 2 uses a comparison between the number of keystrokes per character in the work product 200, which reduces the processing load of the system when compared to conventional methods of detecting whether a work was generated by an undesirable source. In addition, using information such as the number of words or the number of characters in a document as input data makes use of existing information in word processing files. For example, programs like Microsoft Word save this information in the meta data of files such that obtaining this information does not require additional processing of the computer's processor. As discussed above, this is an improvement over existing methods of determining whether a work is generated by AI, which require large amounts of computer processing.

### (1-4) Modifications

Modifications to the above-discussed method performed using the application is discussed below. These modifications may be used in addition to or separately from the above-discussed method.

### Example 3—Number of Characters Over Time

As a third example, either in addition to or instead of the first and second examples, a third solution for determining the variable representative of how the content of the work product 200 is generated is as follows. Example 3 relies on the inventor's discovery that copying and pasting text into the work product 200 creates a disparity between the amount of time it takes to enter a number of characters into the work product 200 and the number of characters in the work product 200. In view of this discovery, the first value indicating the first characteristic of the content of the work product 200 is the amount of time it takes to enter a number of characters into the work product 200 and the second value indicating the second characteristic of the content of the work product 200 is the number of characters in the work product 200.

In the third example, referring again to Step 700, the analysis performed on the work product package 202 includes calculating the variable that is representative of how the content of the work product 200 was generated. In this example, the variable may be a ratio between the amount of time it takes to enter a number of characters into the work product 200 and the number of characters in the work product 200. The application may cause the output apparatus 3 to display, on the second display 10, the ratio. In addition, the application may cause the output apparatus 3 to display, on the second display 10, the likelihood that the work product 200 was generated by AI/NLP based on the ratio. For example, if the ratio is low, the system may assess there to be a “HIGH” likelihood of paste risk. Conversely, if the ratio is relatively high, the system may assess there to be a “LOW” likelihood of paste risk. The ratio may also lead to an assessment of a “MEDIUM” risk, for example, when the ratio is somewhere in between low and high.

The third example provides similar advantages as (i)-(vi), discussed in Example 1. For instance, Example 3 uses a comparison between the amount of time it takes to enter characters and the amount of characters entered, which reduces the processing load of the system when compared to conventional methods of detecting whether a work was generated by an undesirable source. In addition, using temporal information, such as the amount of time it takes to enter characters, improves the reliability of detecting undesirable sources to generate the content of the work product 200 by making it possible to detect, as an example, an automated system that sequentially enters the individual characters into the work product 200 at a rate which humans are not capable.

### Monitor Audit

An audit may be performed, as a threshold condition, to ensure that the application was running while the content of the work product 200 was created. The audit may be performed before, after, or during any step of the above-discussed method. As an example, the audit may include determining whether words have been removed or added when compared to the last session of creating content of the work product 200.

The results of the monitor audit may be displayed on the second display 10 of the output apparatus 3. For example, the results of the monitor audit may be “PASS” or “FAIL.” Pass may indicate that the application was properly running while the content of the work product 200 was created. Fail may indicate that edits to the content of the work product 200 without the application running and that the estimation of how the content of the work product 200 was generated is undeterminable.

### Input Audit

An audit may be performed to provide a risk that the content of the work product 200 was input having been influenced by the use of AI/NLP. This influence may be, for example, that the user was reading text written by AI/NLP and manually copying the text. As another example, the influence may be that software is used to individually type the text written by AI/NLP into work product 200. Real-time information may be collected as the collected information 201 to perform the input audit. Examples of such data include an average words typed per session, words typed per minute, or a backspace rate, e.g., a ratio between the number of characters deleted to the number of characters entered (deletion ratio). The input audit may assess four criteria as follows:
1. Whether the typing speed (e.g., words per minute WPM) used to create the document was faster than a first predetermined threshold, the first predetermined threshold indicating a typing speed of a person.
2. Whether the typing speed to create the work product was faster than a second predetermined threshold, the second predetermined threshold indicates a typing speed of an average student.
3. Whether the number of words written during a single session is improbable given limited attention spans prior to breaking (AVG words per session).
4. Whether the student revised their work as is expected with academic writing (Deletion Ratio).

The Input Audit may be a separate assessment from the Paste Risk Audit. There may be times where both INPUT RISK and PASTE RISK both flag as high risk. For example, when a student pastes their whole essay without revision, the percentage of the content that was pasted into the work will equal 100%, the deletion ratio will be 0%, and the WPM will be 0, thereby resulting in high Paste Risk and Input Risk. Each assessment may be conducted independently of each other.

The results of the input audit may be displayed on the second display 10 of the output apparatus 3. For example, the results of the input audit may be representative of the risk that the content of the work product 200 was input while being influenced by the use of an undesirable source such as AI/NLP. As such, the results of the input audit may be “HIGH,” “MEDIUM,” or “LOW.” The results of the input audit may be presented separately from the above-discussed likelihood of paste analysis and may be used in combination with the above-discussed likelihood of paste analysis for generating an overall estimation of whether the content of the work product 200 was generated using an undesirable source such as AI/NLP. This overall estimation may be calculated by factoring in individual examples, such as the average words typed per session, the words typed per minute, or the backspace rate, or it may be calculated based on a combination (e.g., a summation) of these individual examples. In addition, the second display 10 of the output apparatus 3 may display the data used to generate the results of the input audit. In other words, the average words typed per session, the words typed per minute, and/or the backspace rate may be displayed on the second display 10.

The results of the input audit provide yet another improvement by providing detailed information that may be obtained over a predetermined amount of time. As an example, using the word types per minute as a factor for the overall estimation of whether the work product 200 was generated using an undesirable source, such as AI/NLP, allows for additional detection in a situation where the student may simply retype content generated by AI/NLP or uses third party software to type the content generated by AI/NLP into a document.

Determining whether or not the work product 200 was generated using an undesirable source, such as AI/NLP, may be performed by using, individually or in combination, the results of the paste risk for words, the paste risk for characters, the monitor audit, and the input audit. The results may be displayed by the second display 10 of the output apparatus 3, as shown in FIG. 7.

### Event Log

The output apparatus 3 may be configured to display, on the second display 10, an event log. The event log may include details regarding specific actions taken while generating the content of the work product 200. For example, the event log may include the number of words pasted into the work product 200 at a time and may include the number of words cut from the work product 200 at a time.

It will be appreciated that the above-disclosed features and functions, or alternatives thereof, may be desirably combined into different systems, apparatuses and methods. Also, various alternatives, modifications, variations or improvements may be subsequently made by those skilled in the art, and are also intended to be encompassed by the disclosed embodiments. As such, various changes may be made without departing from the spirit and scope of this disclosure.

Although specific embodiments were described herein, the scope of the invention is not limited to those specific embodiments. The scope of the invention is defined by the following claims and any equivalents therein.

As will be appreciated by one skilled in the art, aspects of the present disclosure may be embodied as a system, a method or a computer program product embodied in one or more computer readable medium(s) having computer readable program code embodied thereon.

Any combination of one or more computer readable medium(s) may be utilized. The computer readable medium may be a computer readable signal medium or a non-transitory computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the non-transitory computer readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a non-transitory computer readable storage medium may be any tangible medium that can contain, or store a program for use by or in connection with an instruction execution system, apparatus, or device.

Aspects of the present disclosure are described above with reference to flowchart illustrations and block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowcharts and block diagrams in the Figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems which perform the specified functions or acts, or combinations of special purpose hardware and computer instructions.

What is claimed is:

1. A method for calculating a first variable representative of how a content of a work product is generated, the method comprising:
recording, by a first processor, in a first memory, (i) a first value indicating a first characteristic of the content of the work product and (ii) a second value indicating a second characteristic of the content of the work product;
transmitting, from the first memory to a second memory, the first and second values;
retrieving, by a second processor distinct from the first processor, from the second memory, the first and second values; and
calculating, by the second processor, the first variable representative of how the content of the work product was generated based on the first and second values.

2. The method according to claim 1, wherein the first characteristic of the content of the work product is an amount of time to enter a number of characters in the work product.

3. The method according to claim 2, further comprising receiving a real-time input of a user generating the content of the work product, the real-time input of the user establishing the number of characters entered in the work product.

4. The method according to claim 2, wherein the second characteristic of the content of the work product is the number of characters entered in the work product.

5. The method according to claim 4, wherein
the first variable is a ratio between the first and second values, the ratio indicating an amount of the content that was pasted into the work product.

6. The method according to claim 5, wherein the method further comprises:
calculating, by the second processor, a likelihood that the work product was generated by artificial intelligence, the likelihood being based on the percentage.

7. The method according to claim 1, wherein the first characteristic of the content of the work product is a number of words typed in the work product.

8. The method according to claim 7, wherein the second characteristic of the content of the work product is a word count of the work product.

9. The method according to claim 8, wherein
the first variable is a ratio between the first and second values, the ratio indicating an amount of the content that was pasted into the work product.

10. The method according to claim 9, wherein the method further comprises:
calculating, by the second processor, a likelihood that the work product was generated by artificial intelligence, the likelihood being based on the ratio.

11. The method according to claim 1, wherein the method further includes:
estimating a likelihood that the work product was generated by artificial intelligence based on (i) an average number of words per session, each session being a duration during which the work product was opened and closed a single time, (ii) an average number of words typed per minute, or (iii) a ratio between a number of characters deleted and the first value.

12. The method according to claim 10 further comprising:
determining, as a threshold condition, whether the work product satisfies criteria indicating that content tracking software was used while generating the content of the work product, and
reporting, when the threshold condition is not met, that the likelihood is undeterminable.

13. The method according to claim 1, wherein the first memory is housed in a first computer and the second memory is housed in a second computer, separate from the first computer.

14. The method according to claim 1, wherein the first value is obtained repeatedly over a predetermined amount of time.

15. The method according to claim 6, wherein the number of keystrokes are generated by a user physically pressing the keys of a keyboard while generating the content of the work product.

16. The method according to claim 1, wherein the method further comprises:
recording, by the first processor, in the first memory, a third value indicating a third characteristic of the content of the work product;
transmitting, from the first memory to the second memory, the third value;
retrieving, by the second processor, from the second memory, the third value; and
calculating, by the second processor, a second variable representative of how the content of the work product was generated by comparing the third variable to a threshold.

17. The method according to claim 16, wherein
the first variable is a ratio between the first and second values, the ratio indicating an amount of the content that was pasted into the work product.

18. The method according to claim 17, wherein the method further comprises:
calculating, by the second processor, a likelihood that the work product was generated by artificial intelligence, the likelihood being based on the ratio and whether the third variable is higher than the threshold.

19. A non-transitory computer readable medium for calculating a first variable representative of how a content of a work product is generated, the non-transitory computer readable medium storing a program that is executable by a computer to perform processing, the processing comprising:
retrieving, from a memory, first and second values, the first value indicating a first characteristic of the content of the work product and the second value indicating a second characteristic of the content of the work product, and
calculating, the first variable representative of how the content of the work product was generated based on the first and second values.

20. A system for calculating a first variable representative of how a content of a work product is generated, the system comprising:
a first processor including a first memory, the first processor being configured to:
record a first value indicating a first characteristic of a content of a work product over time,
record a second value indicating a second characteristic of the content of the work product, and
transmit, to a server, the first and second values;
the server, configured to transmit the first and second values to a second processor including a second memory; and
the second processor including the second memory, the second processor distinct from the first processor, the second processor being configured to,
receive, in the second memory, the first and second values,
retrieve, from the second memory, the first and second values, and
calculate the first variable representative of how the content of the work product was generated based on the first and second values.
